(19) United States
(12) Patent Application Publication
(10) Pub. No.: US 2018/0247278 A1
(43) Pub. Date: Aug. 30, 2018

(54) MAINTENANCE OF A TRANSPORTATION FACILITY WITHIN A BUILDING USING A MOBILE DEVICE

(71) Applicant: Inventio AG, Hergiswil (CH)

(72) Inventors: Rolf Winz, Sursee (CH); Domenico De Piano, Kriens (CH)

(21) Appl. No.: 15/755,229

(22) PCT Filed: Sep. 2, 2016
(86) PCT No.: PCT/EP2016/070731

§ 371 Date: Feb. 26, 2018

(30) Foreign Application Priority Data
Sep. 2, 2015 (EP) 15183575.8

(51) Int. Cl. G06Q 10/00; G06T 7/00

(52) U.S. Cl. CPC G06Q 10/20; G06T 7/0004

(57) ABSTRACT

A method for maintenance of a transportation facility within a building includes: receiving image data of a component of the facility, the image data generated with a camera of a mobile device directed towards the component; identifying the component by evaluating the image data; retrieving maintenance data associated with the identified component from a central maintenance database; and displaying the maintenance data in the mobile device.

### FIELD

The present invention relates to a method, a computer program and a computer-readable medium for maintenance of a transportation facility with a building, such as an elevator, an escalator or a moving walkway. Furthermore, the invention relates to a mobile device and to a maintenance system.

### BACKGROUND

Routine maintenance is an essential procedure to ensure the continuous and proper functioning of a transportation facility for persons and/or goods. During such maintenance, a service technician needs to inspect various components of these facilities to determine whether they are correctly working or whether they need to be updated, repaired or exchanged. Since these facilities are highly customized, the service technician requires a substantial amount of knowledge of and experience with the different types and versions of the components to be inspected. Usually, a service technician identifies the component manually based on his knowledge and then consults hardcopies of technical documentation relevant to the identified component. Accordingly the technician may have to carry large amounts of documents and it is difficult to ensure that the documentation that the technician has is the most up-to-date version.

Although some control devices of such facilities may provide diagnostic information, there usually is no support at the facility site to automatically provide the service technician with the relevant technical documentation or to enable the service technician to analyze the diagnostic information. Diagnostic information, for example, may be encoded in the on-and-off-states of light emitting diodes attached to components. It may be read via a cable connection into a laptop, in which special software for evaluating the diagnostic data has to be present as described in, for example, US-A1-20050061586, U.S. Pat No. 5,522,480 or US-A1-2005077117.

Additionally, transportation facilities for persons and/or goods usually have a very long lifetime. For elevators, for example, the lifetime may be up to 30 or even 50 years. During this relatively long lifespan, components are customarily exchanged with newer versions, the facility may be further modified and/or diagnostic software may be upgraded. Therefore, keeping the maintenance process for these facilities up-to-date can be very challenging.

There may be a need for simplifying the maintenance of these facilities and/or for supporting a service technician with better, more detailed and up-to-date information/documentation during the maintenance.

### SUMMARY

An aspect of the invention relates to a method for maintenance of a transportation facility within a building. For example, the facility may be an elevator (for persons and/or goods), an escalator or a moving walkway. The method may be a computer-implemented method completely executed by a mobile device.

According to an embodiment of the invention, the method comprises: receiving image data of a component of the transportation facility, the image data generated with a camera of a mobile device directed towards the component; identifying the component by evaluating the image data; retrieving maintenance data associated with the identified component from a central maintenance database; displaying the maintenance data in the mobile device.

For example, a service technician may carry the mobile device with him and may direct the camera of the mobile device to the component to be inspected. The mobile device and/or a maintenance database may recognize the component to be inspected/maintained based on evaluating the image data captured by the mobile device. In the end, the maintenance database may send maintenance data (such as further information of the component, important features of the component to be inspected and/or maintenance documents, or the necessary steps or procedures that need to be carried out to complete the maintenance) to the mobile device and the mobile device may display maintenance related data to the service technician.

Summarized, a component of the facility may automatically be detected and identified by using the camera of a mobile device. This data may be used to provide the service technician with further maintenance information from a central maintenance database.

This may result in efficiency and quality improvements in maintenance by getting always the correct diagnostic information and documentation. Furthermore, the service technician may save time and the customer satisfaction may be increased through a service of high quality.

The central maintenance database may be provided by an internet server (for example in a cloud computing facility). Communication between the mobile device and the maintenance database may be provided by a wireless internet connection of the mobile device. The central maintenance database may be based on a spare part management system and maintenance report back system.

According to an embodiment of the invention, a pattern recognition algorithm identifies the component based on geometrical features of the component. The geometrical features may be provided by the maintenance database. For example, the mobile device may retrieve geometrical features of components of the facility from the central maintenance data base, such as the outer form of a component (for example a cube, a cylinder, etc.) and/or an arrangement of a part of the component (for example, the position of a screw, a flap, a cover, etc.). Features of the component may be extracted from the image data and may be compared with the features of a component from the maintenance database. In the case of a match, it may be assumed that the component in the image data is the component represented in the maintenance database.

The set of possible components to be identified may be restricted with information of the facility. For example, the specific facility may be identified and the possible components to be identified may be restricted to the components actually used in the specific facility. Such information also may be stored in the central maintenance database. The identification of the specific facility may be performed manually by the service technician, with GPS coordinates from the mobile device and/or via an electronic fault report, which initiated the inspection of the facility.

According to an embodiment of the invention, the component carries a graphical code identifying the component. The component may be recognized by extracting the graphical code from the image data and evaluating the graphical code. For example, some or all components of the facility may be provided with graphical codes (which may be attached to the component or may be displayed on a display of the component), such as barcodes and/or QR codes. The code may be extracted from the image data and the information encoded therein, such as component type, component version, etc., may be used for identifying the component.

According to an embodiment of the invention, the method further comprises: identifying a maintenance state of the component by evaluating the image data. It also may be possible not only to identify the component but additionally to extract information from the image data that support the service technician in the maintenance of the specific component. For example, maintenance data may be diagnostic information, information on the wear of the component, the need to replace, to repair a component, etc.

According to an embodiment of the invention, a graphical display of the component indicating the maintenance state is extracted from the image data and evaluated to identify the maintenance state. It has to be noted that the graphical display may show human readable information (such as a diagram and/or text/numbers). The information from the image data may be converted back into text and/or numbers. Then, an interpretation of the text/the numbers may be provided to the service technician.

In such a way, also older components and/or components without a machine-to-machine interface may be included into automatic maintenance, which may simplify maintenance of a transportation facility by unexperienced personal. Additionally, many electronic components may be designed simpler, since only a human-readable display may be provided. While it is possible that these components are maintained without support of a mobile device, the automated maintenance with the mobile device may be performed faster and much more securely. Furthermore, with the above technical features it is no longer necessary to provide a machine-to-machine interface for the technical components to be inspected. Thus, technical equipment may be saved and may be designed simpler.

According to an embodiment of the invention, the maintenance state is displayed by at least one light emitting diode, which on-and-off-state is extracted from the image data. The resulting code may be provided with an interpretation from the central maintenance database. For example, the maintenance database may store lists with texts explaining the various combinations of on and off LEDs. Also the meaning of on-and-off states of LEDs may be stored and/or the interpretation of diagnostic data may be stored.

According to an embodiment of the invention, possible maintenance states and their meaning (i.e. a text explaining the maintenance state) are stored in the central maintenance database. For example, it may be stored that the specific component may be subjected to wear and that, for example, this wear may be seen by the profile depth of the component. According to an embodiment of the invention, the maintenance state is determined from a graphical feature of the component in the image data. A further possibility is to directly determine the maintenance state (such as “is defect”, “wear”, “old version”) from the image data. For example, a red cable may indicate rust. Furthermore, the filling level of an oil tank may be automatically determined by evaluating the image data.

According to an embodiment of the invention, the image data is sent to the central maintenance database and evaluated by the central maintenance database. A first possibility is to evaluate the image data in the maintenance database, when the computing power of the mobile device is too low and/or when the corresponding algorithms should not be stored in the mobile device. However, it also may be possible that the image data is evaluated in the mobile device, for example with a self-installing and/or automatically updating app.

According to an embodiment of the invention, the method further comprises: generating overlay data for the image data from data provided by the maintenance database; and displaying the overlay data together with the image data in the mobile device such that an augmented reality image is generated. It may be possible that the central maintenance database does not only store textual data and/or documents but that the maintenance database provides the mobile device with information such that the mobile device is able to display an augmented reality to the technician. It may be possible that the mobile device is augmented reality glasses.

A further aspect of the invention relates to a computer program, which, when being executed on at least one processor, is adapted for carrying out the steps of the method as described in the above and in the following. For example, the mobile device and/or the maintenance database may comprise such processors.

A further aspect of the invention relates to a computer-readable medium in which such computer program is stored. For example, the computer program may be or may comprise a self-installing app in the mobile device. Also, at least some parts of the computer program may be provided in the central maintenance database.

In general, a computer-readable medium may be a floppy disk, a hard disk, SD card, an USB (Universal Serial Bus) storage device, a RAM (Random Access Memory), a ROM (Read Only Memory), an EPROM (Erasable Programmable Read Only Memory) or a FLASH memory. A computer-readable medium may also be a data communication network, e.g. the Internet, which allows downloading a program code. The computer-readable medium may be a non-transitory or transitory medium.

A further aspect of the invention relates to a mobile device adapted for performing the steps of the method as described in the above and in the following. For example, the mobile device may be a laptop, smartphone or tablet computer. In particular, the mobile device may need a camera to generate the image data and/or may have to be adapted to establish a communication connection with the central database, for example via mobile Internet.

A further aspect of the invention relates to a maintenance system, which comprises a central maintenance database providing maintenance data for a transportation facility and at least one mobile device communicatively interconnected with the central maintenance database. The at least one mobile device and the central maintenance database may be adapted for performing the steps of the method described in the above and in the following.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 schematically shows a maintenance system according to an embodiment of the invention.

FIG. 2 shows a record from a maintenance database for the system of FIG. 1.

FIG. 3 shows a flow diagram for a method for maintenance of a transportation facility according to an embodiment of the invention.

The figures are only schematic and not to scale. Same reference signs refer to same or similar features.

### DETAILED DESCRIPTION

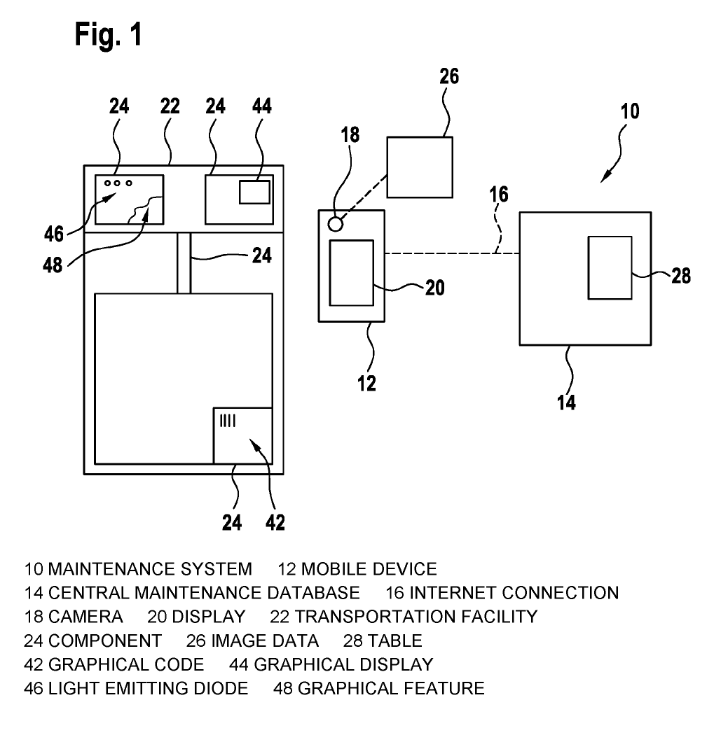

FIG. 1 shows a maintenance system 10 comprising a mobile device 12 and a maintenance database 14, which may be provided by an internet server, which is interconnected via the Internet 16 with the mobile device 12. For example, the mobile device 12 may be adapted for establishing a wireless internet connection 16 with the maintenance database 14. Furthermore, the mobile device 12, which may be a smartphone or tablet computer, comprises a camera 18 and a display 20.

FIG. 1 additionally shows a transportation facility 22 in the form of an elevator. However, the facility 22 also may be an escalator or a moving walkway. As indicated in FIG. 1, the facility 22 may have several components 24 (which may be seen as members and/or modules of the facility 22 that may be exchanged as a whole).

During maintenance, a service technician may use the maintenance system 10 to inspect the facility 22. For example, he may direct the camera 18 of the mobile device towards one of the components 24 and the camera 18 generates image data 26 associated with the component 24. After that, the image data 26 is analyzed by the maintenance system 10 (by the mobile device 12 and/or the database 14) and the specific component 24 is identified by the maintenance system 10. Based on the identification, the maintenance database 14 may provide maintenance data for the specific component 24, which, for example, may be displayed on the display 12 of the mobile device 10.

The data associated with the components 24 of the facility 22 may be stored in a table 28.

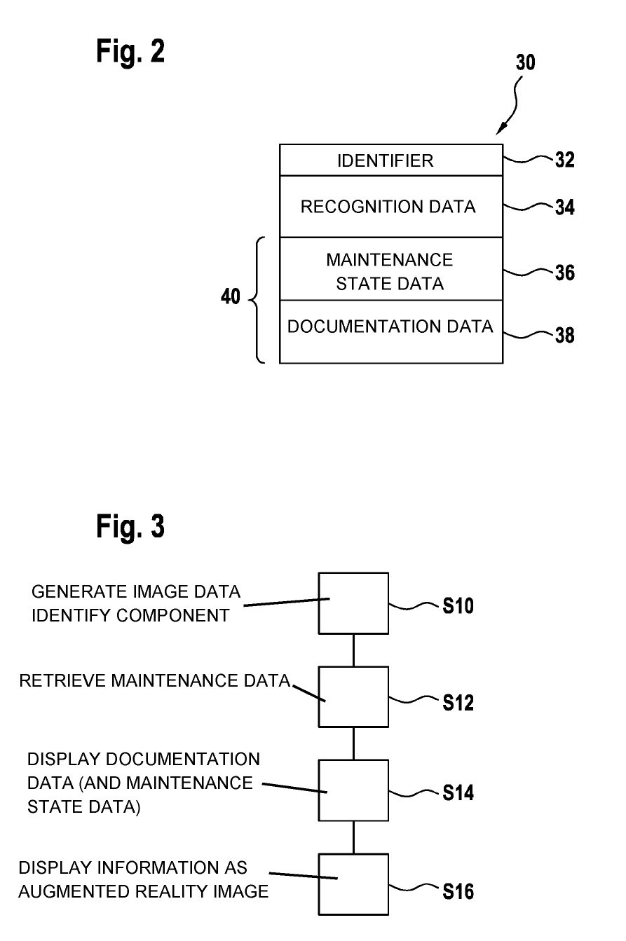

FIG. 2 shows a record 30 of this table 28. The record comprises an identifier 32 for a type of component 24, recognition data 34 to be used during the identification of the specific component 24, maintenance state data 36 used to decode maintenance states and/or to provide information about maintenance states of the component and documentation data 38 used to provide maintenance documentation by the maintenance database 14.

The identifier 32 or identification data 32 may comprise information on the name, the version, the manufacturing date, etc., which make it possible to uniquely identify a specific type of component 24. It has to be noted that the record 30 may be associated with a specific type of component 24, i.e. two identical components 24 (for example used in two different facilities 22) may be associated with the same record 30.

The maintenance state data 36 and the documentation data 38 may be seen as maintenance data 40 of the associated component 24.

FIG. 3 shows a method for maintenance of the transportation facility 22.

In step S10, the service technician directs the camera 18 of the mobile device 12 towards a component 24 of the facility 22. The camera 18 generates image data 26 that is evaluated by the mobile device 12 to identify the component 24.

For example, a pattern recognition algorithm identifies the component 24 based on geometrical features of the component 24. The maintenance database 14 may provide a set of geometrical features to be identified for each possible component 24, which are stored in the respective record 30 in the recognition data 34. For example, these features comprises geometrical forms, colors, edges, etc. that may be detected for a specific component 24. When the features uniquely identify a component and all features of a component 24 are extracted from the image data 26, it may be assumed that the camera 18 has been directed towards a component 24 of the same type as stored in the database 14.

It also may be possible that the component 24 carries a graphical code 42 (see FIG. 1) identifying the component 24. Such a code 42 may be a barcode or a QR code. The component 24 is then identified/recognized by extracting the graphical code 42 from the image data 26 and evaluating the graphical code 42. For example, in the graphical code 42, the identifier 32 may be encoded. Also, the recognition data 34 may comprise information associating a graphical code 42 with a component 24.

Alternatively, the image data 26 is sent via the Internet connection 16 to the maintenance database 14 and evaluated there as described with respect to the mobile device 12. Furthermore, in a further embodiment, the extracted features may be sent to the database 14 and used there for identifying the specific component 24.

The set of recognition data 34 to be searched for identifying a component may be restricted, when the components used in the facility 22 are known. For example, the facility 22 may be manually identified by the service technician and/or may be identified with GPS coordinates from the mobile device 12. When information on which components are used in the facility 22 is stored in the database 14, the components 24 to be searched for during identification may be restricted to these specific components 24.

In step S12, maintenance data 40 is retrieved by the mobile device 12 from the database 14.

If the maintenance data 40 comprises maintenance state data 36, which indicates that also a maintenance state may be extracted from the image data 26, the mobile device 12 furthermore extracts the specific information from the image data 26. In general, the mobile device 12 may be adapted for identifying a maintenance state of the component 24 by evaluating the image data 26.

For example, the maintenance state data 36 may indicate that the component 24 has a graphical display 44 (such as an LCD), which shows diagnostic data, the content of the graphical display 44 may be extracted by the mobile device 12 from the image data 26 and evaluated. For example, text and/or numbers displayed may be translated into a text string and/or a number.

It also may be possible that the maintenance state data 36 indicates that a maintenance state is displayed by at least one light emitting diode 46. The on-and-off-state of the LED 46 (i.e. whether the LED 46 is glowing or not) may then be extracted from the image data 26.

Alternatively or additionally, the maintenance state may also be determined from a graphical feature 48 of the component 24 in the image data 26. For example, the maintenance state data 36 may indicate that a specific color at a specific position on the component 24 may mean that the component is rusty. As a further example, the maintenance state data 36 may provide a position/area on the component 24, where the filling level of a fluid such as oil may be seen (for example behind a window). Such a graphical feature 48 may be extracted by the mobile device 12 from the image data and evaluated.

It has to be understood that the maintenance state data 36 also may comprise information, where a graphical feature 48, an LED 46 or a display 44 may be found on the component 24.

The maintenance state data 36 furthermore may comprise information about how to interpret the specific maintenance state. For example, a specific combination of LEDs may indicate a specific error code, which then may be provided in text form to the service technician. Or there may be limits on diagnostic data, which, when exceeded, indicate a specific fault or error, which also may be provided in text form to the service technician.

It has to be understood that alternatively the maintenance state may be extracted from the image data 26 by the database 14.

In step S14, the documentation data 38 (or electronic documents provided by the database 14 associated therewith) and optionally the maintenance state data 36 (such as explanation of error codes, etc.) are displayed on the display 20 of the mobile device 12. For example, the mobile device 12 may show the service technician that the component 24 has a specific fault and/or may advise the service technician how to proceed further. For example, the mobile device 12 may show the service technician, how the identified component 24 may be exchanged or repaired.

In optional step S16, the service technician is supported by the mobile device 12, which displays the information described above as an augmented reality image. The mobile device 12 may overlay image data for the image data 26, for example from data provided by the maintenance database 14. After that, the overlay image data may be displayed together with the image data 26 in the mobile device 12 such that the service technician sees the image taken by the camera 18 overlaid with specific information at dedicated positions inside the image. For example, an explanation of an error code may be displayed besides the image of a display 44 and/or LEDs 46.

Finally, it should be noted that the term “comprising” does not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE SIGNS

10 maintenance system
12 mobile device
14 central maintenance database
16 Internet connection
18 camera
20 display
22 transportation facility
24 component
26 image data
28 table
30 record
32 identifier
34 recognition data
36 maintenance state data
38 documentation data
40 maintenance data
42 graphical code
44 graphical display
46 light emitting diode
48 graphical feature

1-13. (canceled)

14. A method for maintenance of a transportation facility, the method comprising the steps of:
providing a mobile device to a service technician;
receiving image data of a component of the facility, the image data being generated with a camera of the mobile device directed towards the component;
identifying the component by evaluating the image data with a processor;
establishing a communication connection between the mobile device and a central maintenance database;
retrieving maintenance data associated with the identified component from the central maintenance database over the communication connection;
displaying the maintenance data on the mobile device;
identifying a maintenance state of the component by evaluating the image data on the processor wherein a graphical display of the component showing human readable information is extracted from the image data and evaluated by the processor to identify the maintenance state; and
providing an interpretation of the maintenance state to the service technician by a display on the mobile device.

15. The method according to claim 14 including using a pattern recognition algorithm to identify the component based on geometrical features of the component, wherein the geometrical features are provided by the maintenance database.

16. The method according to claim 14 wherein the component carries a graphical code identifying the component and identifying the component by extracting the graphical code from the image data and by evaluating the graphical code.

17. The method according to claim 14 wherein the maintenance state is displayed by at least one light emitting diode and an on-and-off-state of the at least one light emitting diode is extracted from the image data.

18. The method according to claim 14 wherein possible maintenance states and associated meaning are stored in the central maintenance database.

19. The method according to claim 14 wherein the maintenance state is determined from a graphical feature of the component in the image data.

20. The method according to claim 14 including sending the image data from the mobile device to the central maintenance database and evaluating the image data by the central maintenance database, or evaluating the image data by the mobile device.

21. The method according to claim 14 further comprising the steps of:
generating overlay data for the image data from data provided by the maintenance database; and
displaying the overlay data together with the image data on the mobile device to generate an augmented reality image.

22. The method according to claim 14 wherein the transportation facility includes at least one of an elevator, an escalator and a moving walkway.

23. A computer program, which, when being executed on the processor, is adapted for carrying out the steps of the method according to claim 14.

24. A non-transitory computer-readable medium in which the computer program according to claim 23 is stored.

25. A mobile device adapted for performing the steps of the method according to claim 14.

26. A maintenance system comprising:
a central maintenance database providing maintenance data for a transportation facility;
a mobile device communicatively interconnected with the central maintenance database; and
wherein the mobile device and the central maintenance database are adapted for performing method steps of:
generating image data of a component of the facility with a camera of the mobile device directed towards the component;
identifying the component by evaluating the image data with a processor;
retrieving maintenance data associated with the identified component from the maintenance data provided by the central maintenance database;
displaying the maintenance data on the mobile device;
identifying a maintenance state of the component by evaluating the image data on the processor wherein a graphical display of the component showing human readable information is extracted from the image data and evaluated by the processor to identify the maintenance state; and
providing an interpretation of the maintenance state to a service technician by a display on the mobile device.
